(19) United States
(12) Patent Application Publication
(10) Pub. No.: US 2021/0131183 A1
(43) Pub. Date: May 6, 2021

(54) Protection Pad for Ladders and/or Gutters

(71) Applicant: Specialty Solutions LLC, Honea Path, SC (US)

(72) Inventor: William Lee Thompson, Honea Path, SC (US)

(21) Appl. No.: 16/671,616

(22) Filed: Nov. 1, 2019

(51) Int. Cl. E06C 7/48

(52) U.S. Cl. CPC E06C 7/486

(57) ABSTRACT

A ladder pad includes an elongated body that defines a slot extending along a length of the elongated body. The elongated body further defines a plurality of openings. The openings are spaced along the length of the elongated body. The slot of the elongated body is sized for receipt of a rail of a ladder and/or an edge of a gutter. Each of the openings is sized and positioned for receipt of a respective rung of the ladder and/or a standoff bracket of the gutter.

### FIELD OF THE INVENTION

The present subject matter relates generally to protection pads for ladders and/or gutters.

### BACKGROUND OF THE INVENTION

Ladders are frequently used to access rooftops and other portions of a building. For instance, a ladder can be leaned against a building, and a user may climb the ladder to access the building's rooftop, gutters, etc. In some circumstances, leaning ladders against a building causes damage to the building.

Leaning a ladder against a gutter is particularly problematic. As the user climbs the ladder, the ladder can scratch the gutter, and the weight of the user can dent and deform the gutter. Damaged gutters can look unattractive and may no longer function properly. Repairing damaged gutter is an expensive and time-consuming process.

A need exists for a tool to allow ladders to be leaned against a building without damaging the building.

### BRIEF DESCRIPTION OF THE INVENTION

Aspects and advantages of the invention will be set forth in part in the following description, or may be apparent from the description, or may be learned through practice of the invention.

In an example embodiment, a ladder and/or gutter protection pad includes an elongated body that defines a slot extending along a length of the elongated body. The elongated body further defines a plurality of openings. The openings are spaced along the length of the elongated body. The slot of the elongated body is sized for receipt of a rail of a ladder. Each of the openings is sized and positioned for receipt of a respective rung of the ladder.

In another example embodiment, a ladder and/or gutter protection pad includes an extruded plastic elongated body that defines a slot extending along a length of the extruded plastic elongated body. The extruded plastic elongated body further defines a plurality of openings. The openings are spaced along the length of the extruded plastic elongated body. The extruded plastic elongated body includes a base panel and a pair of side panels. The side panels are formed with and extend outwardly from the base panel such that the slot is disposed between the side panels. The openings are positioned on one of the side panels. The slot of the extruded plastic elongated body is sized for receipt of a rail of a ladder. Each of the openings is sized and positioned for receipt of a respective rung of the ladder. The extruded plastic elongated body is a single, unitary piece of material.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a pair of ladder and/or gutter protection pads according to an example embodiment mounted on a ladder.

FIG. 2 is a perspective view of the example ladder and/or gutter protection pad of FIG. 1.

FIGS. 3 and 4 are left and right side, elevation views of the example ladder and/or gutter protection pad of FIG. 1.

FIG. 5 is an end view of the example ladder pad of FIG. 1 taken along a length of the example ladder and/or gutter protection pad.

FIG. 6 is a perspective view of the example ladder and/or gutter protection pad of FIG. 1 mounted on a gutter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

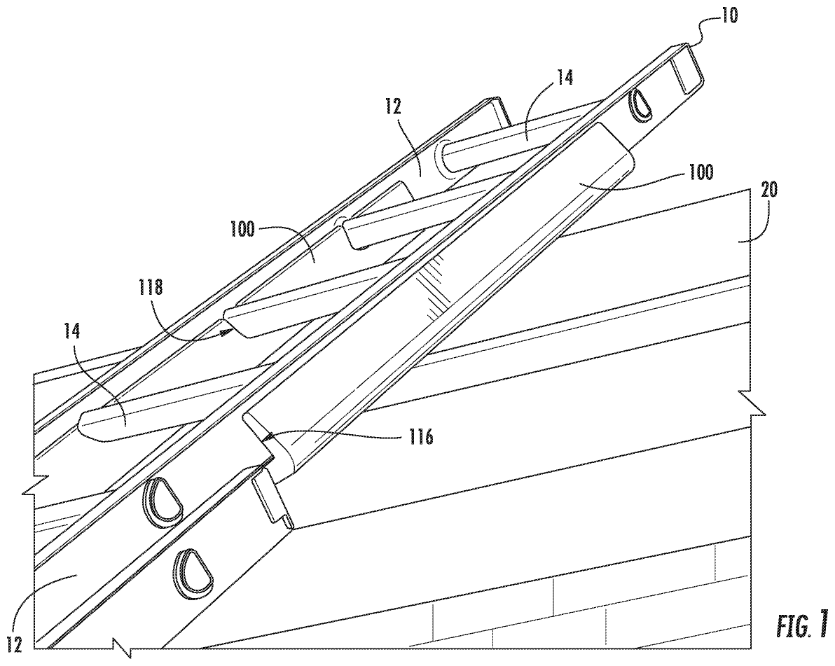

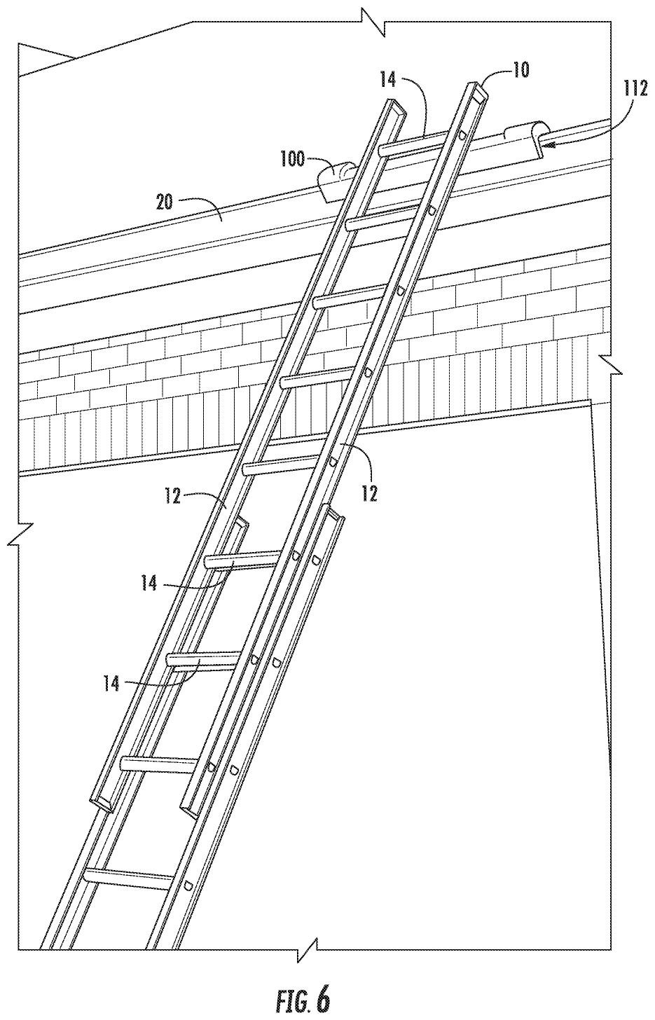

FIG. 1 is a perspective view of a pair of ladder and/or gutter protection pads 100 according to an example embodiment mounted on a ladder 10. Although referred to herein in as a “ladder pad,” ladder pad 100 is not limited to mounting only on ladders, such as ladder 10. As discussed in greater detail herein and as shown in FIG. 6, ladder pad 100 may also be mounted directly on a gutter 20, rather than ladder 10. Thus, ladder pad 100 may also be referred to as a “ladder and/or gutter protection pad,” a “gutter pad,” or a “ladder/gutter pad,” e.g., depending upon how ladder pad 100 is installed by a user. The terms “ladder and/or gutter protection pad,” “ladder pad,” “gutter pad” and “ladder/gutter pad” may be used interchangeably to refer to the pads 100 shown in FIGS. 1 through 6.

As shown in FIG. 1, ladder pads 100 may be mounted on ladder 10 such that ladder pads 100, rather than rails 12 of ladder 10, contact a gutter 20 of a building. In particular, ladder pads 100 may be positioned between ladder 10 and gutter 20 in order to protect gutter 20 from damage by ladder 10, e.g., due to ladder 10 scratching gutter 20 and/or the weight of a user climbing ladder 10 and crushing gutter 20. For instance, ladder pads 100 may assist with protecting gutter 20 by limiting or preventing crushing of gutter 20 as the user climbs ladder 10.

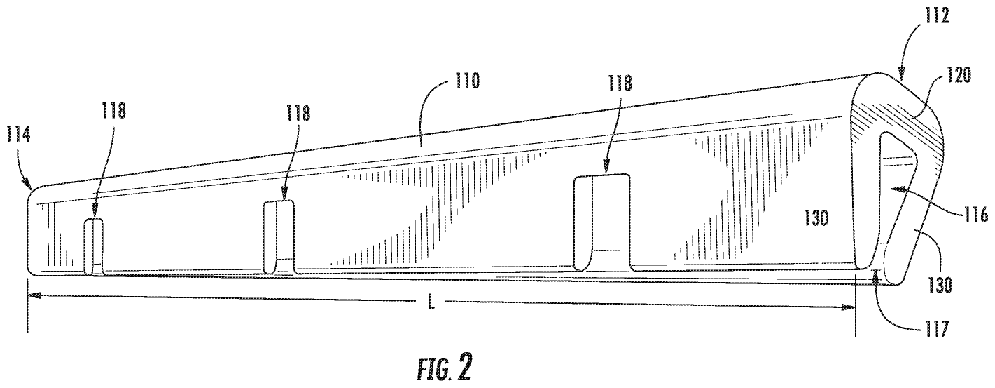

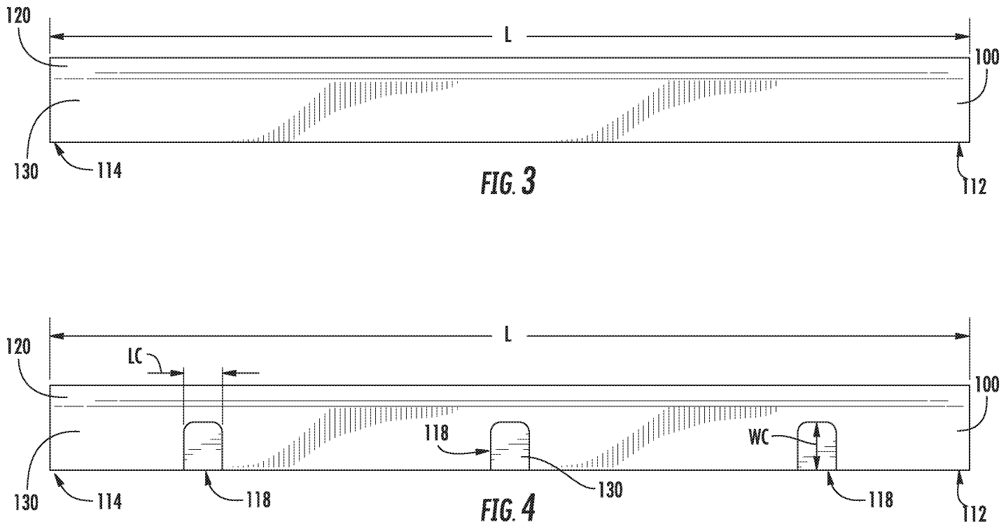

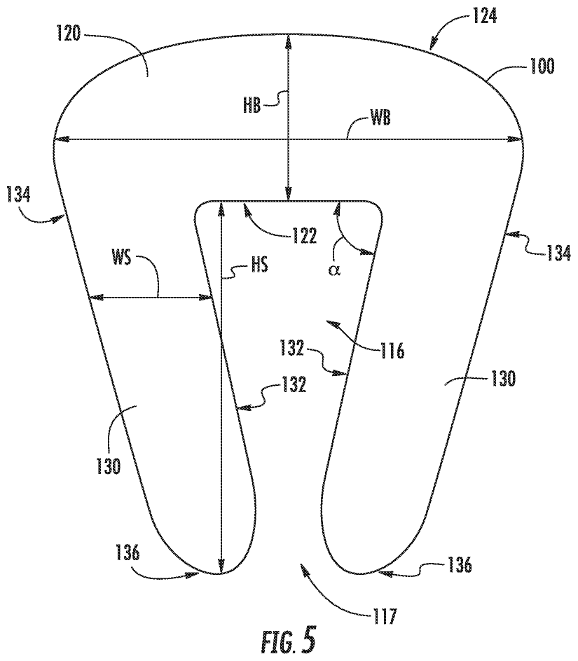

FIG. 2 is a perspective view of a ladder pad 100. FIGS. 3 and 4 are left and right side, elevation views of ladder pad 100. FIG. 5 is an end view of ladder pad 100. Only one of ladder pads 100 is shown in FIGS. 2 through 5, and only one of ladder pads 100 is discussed in greater detail below for the sake of brevity. However, it will be understood that the other of ladder pads 100 shown in FIG. 1 may be formed in the same or similar manner to that described below for the one ladder pad 100 shown in FIGS. 2 through 5. Ladder pads 100 may be interchangeable on rails 12 of ladder 10, e.g., due to ladder pads 100 (FIG. 1) being commonly formed or shaped. Thus, each ladder pad 100 may be mounted to one of the left and right rails 12 of ladder 10 in one orientation and may be flipped to mount the ladder pad 100 on the other of the left and right rails 12 of ladder 10.

With reference to FIGS. 2 through 5, ladder pad 100 includes an elongated body 110. Elongated body 110 extends between a first end portion 112 and a second end portion 114. First and second end portions 112, 114 are positioned opposite each other on elongated body 110, and elongated body 110 may have a length L between first and second end portions 112, 114 of elongated body 110.

Elongated body 110 defines a slot 116 and a plurality of openings 118. Slot 116 may extend along the length L of elongated body 110. In addition, slot 116 may be open on one side of elongated body 110 such that an entrance 117 of slot 116 extends along the length L of elongated body 110. Slot 116 may be sized for receipt of a rail 12 of ladder 10, as shown in FIG. 1. Thus, e.g., a user of ladder 10 may insert rail 12 through entrance 117 of slot 116 until the edge of rail 12 is disposed within slot 116 opposite entrance 117.

Openings 118 may be spaced along the length L of elongated body 110. For example, as shown in FIG. 2, a first one of openings 118 may be positioned adjacent first end portion 112 of elongated body 110, a second one of openings 118 may be positioned adjacent second end portion 114 of elongated body 110, and a third one of openings 118 may be positioned at a middle portion of elongated body 110 between first and second end portions 112, 114 of elongated body 110. Openings 118 may be contiguous with slot 116 and may extend through elongated body 110. Thus, openings 118 may open into slot 116. In addition, each opening 118 may be sized and positioned for receipt of a respective rung 14 of ladder 10, as shown in FIG. 1. For example, the user of ladder 10 may insert rail 12 into slot 116 while rungs 14 are aligned with openings 118. As the user inserts rail 12 into slot 116, rungs 14 may slide into openings 118.

Turning back to FIG. 1 and as discussed above, ladder pad 110 may be mounted to ladder 10 by positioning rail 12 within slot 116 and rungs 14 within openings 118. Interference between rungs 14 and elongated body 110 at openings 118 may advantageously assist with preventing sliding of elongated body 110 on rail 12. In addition, interference between rail 12 and elongated body 110 at slot 116 may advantageously assist with blocking movement of elongated body 110 relative to rail 12, e.g., movement of elongated body 110 perpendicular to the length L of elongated body 110. As may be seen from the above, ladder pad 110 may be quickly and securely mounted to ladder 10 by positioning rail 12 within slot 116 and rungs 14 within openings 118.

The length L of elongated body 110 may be selected to assist with securely mounting ladder pad 110 to ladder 10. For example, the length L of elongated body 110 may be no less than two feet (2 ft.) and no greater than five feet (5 ft.). As a particular example, the length L of elongated body 110 may be about three feet (3 ft.). As used herein, the term “about” means within six inches (6 in.) of the stated length when used in the context of body lengths. Such sizing of length L of elongated body 110 may advantageously allow for forming multiple openings 118 on elongated body 110 and with allowing multiple rungs 14 of ladder 10 to be received within openings 118 when ladder pad 110 is mounted to ladder 10. Thus, multiple rungs 14 of ladder 10 may assist with blocking sliding of ladder pad 100 on rail 12. Such sizing of length L of elongated body 110 may also advantageously allow sufficient protection of gutter 20 across a range of terrain elevations on which ladder 10 can sit. For instance, gutter 20 may rest at first end portion 112 or second end portion 114 of ladder pad 110 depending upon the installation conditions of ladder 10.

The spacing of openings 118 on the length L of elongated body 110 may also be selected to assist with securely mounting ladder pad 110 to ladder 10. For example, each of the openings 118 may be spaced from an adjacent opening 118 by about one foot (1 ft.) along the length L of elongated body 110. Thus, e.g., the first one of openings 118 adjacent first end portion 112 of elongated body 110 may be spaced from the third one of openings 118 at the middle portion of elongated body 110 by about one foot, and the second one of openings 118 adjacent second end portion 114 of elongated body 110 may also be spaced from the third one of openings 118 at the middle portion of elongated body 110 by about one foot. Such spacing of openings 118 may advantageously allow for multiple rungs 14 of ladder 10 to be received within openings 118 when ladder pad 110 is mounted to ladder 10. Thus, multiple rungs 14 of ladder 10 may assist with blocking sliding of ladder pad 100 on rail 12. The spacing of openings 118 may also allow ladder pad 100 to be mounted on either rail 12 of ladder 10 by flipping ladder pad 100.

Elongated body 110 may include any suitable number of openings 118. For example, openings 118 may include no less than two (2) openings 118 and no more than five (5) openings 118. As shown in FIG. 2, openings 118 may include exactly three (3) openings 118 in certain example embodiments. Such number of openings may advantageously provide a useful ladder pad 100 with a balance between sufficient protection of gutter 20 across a range of terrain elevations on which ladder 10 can sit while also being light weight and compact to avoid being cumbersome.

As shown in FIGS. 2 through 5, elongated body 110 may include a base panel 120 and a pair of side panels 130. Base panel 120 and side panels 130 may each extend along the length L of elongated body 110. Side panels 130 may be positioned on and extend outwardly from base panel 120, e.g., perpendicular to the length L of elongated body 110, and slot 116 may be disposed between side panels 130. Openings 118 may be positioned or formed on one of side panels 130. Conversely, the other of side panels 130 may be imperforate and include no openings 118, in certain example embodiments. In alternative example embodiments, both of side panels 130 may include or form openings 118.

Turning to FIG. 5, the end view shown in FIG. 5 may also correspond to the shape of elongated body 110 in various cross-sections taken along the length L of elongated body 110, e.g., in a plane that is perpendicular to the length L of elongated body 110. In particular, the end view shown in FIG. 5 may correspond to the shape of elongated body 110 in cross-sections taken along the length L of elongated body 110 that do not include openings 118. Such cross-sections are discussed in greater detail below in the context of FIG. 5.

With reference to FIG. 5, elongated body 110 may have a cross-section, e.g., in a plane that is perpendicular to the length L of elongated body 110, that is sized and shaped to facilitate mounting of elongated body 110 to ladder 10 and/or protecting gutter 20. For example, base panel 120 may have a width WB and a height HB in the cross-section. The width WB of base panel 120 may be greater than the height HB of base panel 120. For instance, a ratio of the width WB of base panel 120 and the height HB of base panel 120 may about 3:1. As used herein, the term “about” means within ten percent of the stated ratio when used in the context of ratios. In certain example embodiments, the width WB of base panel 120 may be about three inches (3 in.), and the height HB of base panel 120 may be about one inch (1 in.). As used herein, the term “about” means within a half inch (0.5 in.) of the stated width or height when used in the context of panel widths or heights. The above recited, widths WB and heights HB of base panel 120 may advantageously facilitate mounting of elongated body 110 to ladder 10 and/or with protecting gutter 20, e.g., by sizing base panel 120 to significantly exceed a width of rail 12, by sizing base panel 120 to provide a sufficient volume of material for cushioning rail 12 on gutter 20, etc.

In addition, each of side panels 130 may have a width WS and a height HS in the cross-section. The width WS of side panels 130 may be less than the height HS of side panels 130. For example, a ratio of the width WS of side panels 130 and the height HS of side panels 130 may about 1:3. In certain example embodiments, the width WS of side panels 130 may be about three-quarters of an inch (0.75 in.), and the height HS of side panels 130 may be about three inches (3 in.). The above recited, widths WS and heights HS of side panels 130 may advantageously facilitate mounting of elongated body 110 to ladder 10 and/or protecting gutter 20, e.g., by providing a relatively tall side panels 130 that grip rail 12 when ladder pad 100 is mounted to gutter 20.

Side panels 130 may also be angled or oriented to facilitate mounting of elongated body 110 to ladder 10. For example, side panels 130 may be oriented such that an angle, a, is defined between an inner surface 122 of base panel 120 and an inner surface 132 of each side panel 130. The angle α may be about seventy-five degrees (75°). As used herein, the term “about” means within ten degrees (10°) of the stated angle when used in the context of angles. Such angle α may advantageously facilitate mounting of elongated body 110 to ladder 10, e.g., by allowing side panels 130 to grip rail 12 while also providing space for rail 12 to be inserted in slot 116 between side panels 130 away from entrance 117.

As another example, each side panel 130 may extend from a proximal end 134 to a distal end 136. Proximal end 134 of each side panel 130 may be positioned at base panel 120, and distal end 136 of each side panel 130 may be spaced from base panel 120. Thus, e.g., proximal and distal end portions 134, 136 may be positioned opposite each other on side panels 130, and side panels 130 may be cantilevered from base panel 110.

The spacing between side panels 130 (and thus the size of slot 116) may taper from proximal ends 134 to distal ends 136, e.g., along the length L of elongated body 110. In certain example embodiments, proximal ends 134 of side panels 130 may be spaced apart by about one and a quarter inches (1.25 in.), and distal ends 136 of side panels 130 may be spaced apart by about a quarter of an inch (0.25 in.). The above recited spacing may advantageously facilitate mounting of elongated body 110 to ladder 10, e.g., by configuring distal ends 136 of side panels 130 to grip rail 12 while also providing space for rail 12 to be inserted in slot 116 between side panels 130 away from entrance 117.

As shown in FIG. 5, an outer surface 124 of base panel 120 may be curved. Conversely, inner surface 122 of base panel 120 and/or inner surfaces 132 of side panels 130 may be planar. Such shaping of base panel 120 and side panels 130 may facilitate gripping of rail 12 by side panels 130 and force transfer through base panel 120 to gutter 20.

Turning back to FIG. 4, openings 118 may also be sized and shaped to facilitate mounting of elongated body 110 to ladder 10. For example, each opening 118 may have a length LC and a width WC. In certain example embodiments, the length LC of openings 118 may be about one and a half inches (1.5 in.), and the width WC of openings 118 may be about one and three-quarters inches (1.75 in.). As used herein, the term “about” means within a quarter inch (0.25 in.) of the stated length or width when used in the context of opening lengths or widths. The above recited lengths LC and widths WC of openings 118 may advantageously facilitate mounting of elongated body 110 to ladder 10 while providing a tight interface with rungs 14 that assists with securely mounting ladder pad 100 to ladder 10.

Elongated body 110 may be formed using any suitable formation process and with any suitable material. For example, elongated body 110 may be formed in an extrusion process such that elongated body 110 is an extruded plastic elongated body, such as a foamed extruded plastic elongated body. In particular, elongated body 110 may be formed from extruded polyethylene. Elongated body 110 may be formed from any other suitable plastic in alternative example embodiments. Elongated body 110 may also include additives, such as an ultraviolet (UV) inhibitor, a toughness inhibitor, a color dye, etc.

In certain example, embodiments, elongated body 110 may be formed from a single, unitary piece of material. Thus, e.g., base panel 120 and side panels 130 may be formed from the single, unitary piece of material, such as extruded plastic. In alternative example embodiments, elongated body 110 may be formed from multiple, discrete pieces of material joined together. Thus, e.g., base panel 120 and side panels 130 may separately formed and joined together to form elongated body 110.

FIG. 6 is a perspective view ladder pad 100 mounted on gutter 20. As shown in FIG. 6, ladder pad 100 may be mountable on gutter 20 in addition to ladder 10. For instance, a user of ladder 10 may insert a front edge of gutter 20 into entrance 117 of slot 116 until the front edge of gutter 20 is disposed within slot 116 opposite entrance 117. The user may then lean ladder 10 (with or without ladder pads 100 on ladder 10) against the front edge of gutter 20 with reduced risk of damage to gutter 20 comparted to leaning ladder 10 directly on gutter 20. As may be seen from the above, ladder pad 100 provides versatile protection for gutter 20 by mounting to ladder 10 or directly to gutter 20.

To assist with mounting ladder pad 100 on gutter 20, one or more of openings 118 may receive a respective mounting bracket/hanger (not shown) of gutter 20. As will be understood by those skilled in the art, mounting brackets assist with supporting the gutter 20 on a building and may extend across an interior of gutter 20. Openings 118 may receive mounting brackets when ladder pad 100 is positioned on gutter 20 to assist with mounting ladder pad 100 on gutter 20. For example, a user may insert the one of side panels 130 with openings 118 into the interior of gutter 20 with openings 118 aligned with mounting brackets within the interior of gutter 20. As the one of side panels 130 with openings 118 slides into the interior of gutter 20, the mounting brackets may slide into openings 118. Because the mounting brackets slide into openings 118, openings 118 may reduce interference between ladder pad 100 and mounting brackets and allow the front edge of gutter 20 to be more fully inserted into slot 116, e.g., relative to inserting the one of side panels 130 without openings 118 into the interior of gutter 20. Thus, openings 118 may assist with mounting ladder pad 100 to ladder 10 and/or with mounting ladder pad 100 to gutter 20.

As shown in FIG. 1, two ladder pads 100 may be mounted on rails 12 of ladder 100 in certain example configurations. As shown in FIG. 6, one of ladder pads 100 from FIG. 1 may be removed from ladder 10 and mounted on gutter 20. The other of ladder pads 100 from FIG. 1 may also be removed from ladder 10 and mounted on gutter 20, and a second ladder (not shown) may be leaned against the other of ladder pads 100 to reduce the risk of damage to gutter 20. Thus, when two ladder pads 100 are provided, the two ladder pads 100 may be mounted directly on a single ladder 10 and/or the two ladder pads 100 may be mounted directly on gutter 20 to allow usage of two separate ladders with the two ladder pads 100.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A ladder pad, comprising:
an elongated body defines a slot that extends along a length of the elongated body, the elongated body further defines a plurality of openings, the openings are spaced along the length of the elongated body,
wherein the slot of the elongated body is sized for receipt of a rail of a ladder, and each of the openings is sized and positioned for receipt of a respective rung of the ladder.

2. The ladder pad of claim 1, wherein the length of the elongated body is no less than two feet and no greater than five feet.

3. The ladder pad of claim 1, wherein each of the openings is spaced from an adjacent opening by about one foot.

4. The ladder pad of claim 1, wherein the plurality of openings is no less than two openings and no more than five openings.

5. The ladder pad of claim 4, wherein the plurality of openings is three openings.

6. The ladder pad of claim 1, wherein the elongated body comprises a base panel and a pair of side panels, the side panels are positioned on and extend outwardly from the base panel such that the slot is disposed between the side panels, the openings are positioned on one of the side panels.

7. The ladder pad of claim 6, wherein the elongated body has a cross-section in a plane that is perpendicular to the length of the elongated body, the base panel has a width and a height in the cross-section, the width of the base panel is about three inches, the height of the base panel is about one inch, each of the side panels has a width and a height in the cross-section, the width of the side panels is about three-quarters of an inch, the height of the side panels is about two and a quarter inches.

8. The ladder pad of claim 6, wherein each opening has a length and a width, the length of the openings is about one and a half inches, the width of the openings is about one and three-quarters inches.

9. The ladder pad of claim 6, wherein an angle, α, is defined between an inner surface of the base panel and an inner surface of each of the side panels, the angle α is about seventy-five degrees.

10. The ladder pad of claim 6, wherein an outer surface of base panel is curved.

11. The ladder pad of claim 9, wherein the elongated body has a cross-section in a plane that is perpendicular to the length of the elongated body, the base panel has a width and a height in the cross-section, the width of the base panel is about three inches, the height of the base panel is about one inch, each of the side panels has a width and a height in the cross-section, the width of the side panels is about three-quarters of an inch, the height of the side panels is about two and a quarter inches.

12. The ladder pad of claim 1, wherein a proximal end of each of the side panels is positioned at the base panel, a distal end of each of the side panels is spaced from the base panel, the proximal ends of the side panels are spaced apart by about one and a quarter inches, and the distal ends of the side panels are spaced apart by about a quarter of an inch.

13. The ladder pad of claim 1, wherein the elongated body is an extruded plastic elongated body.

14. The ladder pad of claim 13, wherein the extruded plastic elongated body comprises polyethylene.

15. The ladder pad of claim 1, wherein the elongated body is a single, unitary piece of material.

16. A ladder pad, comprising:
an extruded plastic elongated body defines a slot that extends along a length of the extruded plastic elongated body, the extruded plastic elongated body further defines a plurality of openings, the openings are spaced along the length of the extruded plastic elongated body, the extruded plastic elongated body comprises a base panel and a pair of side panels, the side panels are formed with and extend outwardly from the base panel such that the slot is disposed between the side panels, the openings are positioned on one of the side panels,
wherein the slot of the extruded plastic elongated body is sized for receipt of a rail of a ladder, and each of the openings is sized and positioned for receipt of a respective rung of the ladder, and
wherein the extruded plastic elongated body is a single, unitary piece of material.

17. The ladder pad of claim 16, wherein the length of the extruded plastic elongated body is about three feet, each of the openings is spaced from an adjacent opening by about one foot, and the plurality of openings is three openings.

18. The ladder pad of claim 16, wherein the elongated body has a cross-section in a plane that is perpendicular to the length of the elongated body, the base panel has a width and a height in the cross-section, the width of the base panel is about three inches, the height of the base panel is about one inch, each of the side panels has a width and a height in the cross-section, the width of the side panels is about three-quarters of an inch, the height of the side panels is about two and a quarter inches.

19. The ladder pad of claim 16, wherein each opening has a length and a width, the length of the openings is about one and a half inches, the width of the openings is about one and three-quarters inches.

20. The ladder pad of claim 16, wherein a proximal end of each of the side panels is positioned at the base panel, a distal end of each of the side panels is spaced from the base panel, the proximal ends of the side panels are spaced apart by about one and a quarter inches, and the distal ends of the side panels are spaced apart by about a quarter of an inch.
